(19) United States
(12) Patent Application Publication
(10) Pub. No.: US 2013/0210630 A1
(43) Pub. Date: Aug. 15, 2013

(54) SELF-EMULSIFYING OIL

(71) Applicants: Osma M. Musa, Kinnelon, NJ (US); Kolazl S. Narayanan, Wayne, NJ (US); Jenn S. Shih, Paramus, NJ (US); Xin Qu, Shanghai (CN); Tom Zhang, Shanghai (CN); Giovanni Nicole Onnembo, Wayne, NJ (US)

(72) Inventors: Osma M. Musa, Kinnelon, NJ (US); Kolazl S. Narayanan, Wayne, NJ (US); Jenn S. Shih, Paramus, NJ (US); Xin Qu, Shanghai (CN); Tom Zhang, Shanghai (CN); Giovanni Nicole Onnembo, Wayne, NJ (US)

(73) Assignee: ISP Investments Inc., Wilmington (DE)

(21) Appl. No.: 13/805,550

(22) PCT Filed: Jul. 1, 2011
(86) PCT No.: PCT/US11/42791

§ 371 Date: Mar. 6, 2013

Related U.S. Application Data
(60) Provisional application No. 61/361,149, filed on Jul. 2, 2010.

(51) Int. Cl. A01N 25/04

(52) U.S. Cl. CPC A01N 25/04
USPC 504/234; 514/383; 504/339

(57) ABSTRACT

A concentrate suitable for forming a stable aqueous composition upon dilution with water includes in one aspect a self-emulsifying oil comprising a modified vegetable oil which is modified with a moiety more polar than the vegetable oil and the polar moiety is attached by a covalent bond to the vegetable oil and an active ingredient.

### CROSS REFERENCE TO RELATED APPLICATIONS

The present application claims the benefit of U.S. Provisional Application No. 61/361,149, filed Jul. 2, 2010, the contents of which are hereby incorporated by reference.

This application is also related to the following applications, the contents of which are hereby incorporated by reference: U.S. patent application Ser. No. 10/926,510, filed Aug. 26, 2004; PCT International Patent Application PCT/US2005/028681, filed Aug. 11, 2005; and Publication No. U.S. 2008/0081059 A1, publication date Apr. 3, 2008.

### BACKGROUND

The present application relates to self-emulsifying oils, and, in particular, to delivery systems based on the self-emulsifying oils described herein.

Many chemicals and, in particular, agricultural chemicals, are typically applied in the form of aqueous emulsions, solutions, or suspensions. One of the problems with liquid formulations is the fact that many useful chemicals often exhibit extreme insolubility in water. This results in their having to be dissolved either in organic solvents or utilized in the form of emulsions or suspensions. With respect to the use of organic solvents, these are generally disadvantageous from an environmental and cost viewpoint.

When attempts are made to provide emulsified or suspension formulations, difficulties are encountered with respect to providing a desirably high concentration of the active ingredient. Thus, when such active chemicals are formulated into an emulsion, it is difficult to maintain the emulsified state. This makes it difficult to maintain a uniform formulation, particularly, when the formulation is diluted with water for application.

Typically, for example, the active ingredient is mixed with one or more of a variety of conventional solvents and an emulsifying agent to form a concentrate. This concentrate may be an emulsion, suspension, or solution. The concentrate is then stored until it is transported to the site of use or may simply be transported and stored at the site of use. In any event, the concentrate normally will undergo some period of storage until it is ready for use. Understandably, it is most desirable to be able to transport the active ingredient at the highest concentration possible so as to minimize the volume of material which needs be transported. By the same token, however, at the use site, it is normally not feasible to admix ingredients together or to process them other than to dilute the concentrate with water. Accordingly, it is important that the concentrate emulsify easily, i.e., exhibit good “bloom”, upon the addition of water. In addition, at the use site, it is often necessary to store the diluted concentrate for extended time periods until the actual application of the composition. Consequently, it is important that the diluted form of the concentrate exhibit good stability with respect to the uniformity of the emulsion and to avoid precipitation of the active ingredients. If non-uniformity or precipitation occurs in the diluted form, then non-uniformity will result in the application of the diluted formulation which would limit the effectiveness of the active ingredient.

It is also desirable to utilize a delivery system for the concentrate that is low cost, uses green components and is biodegradable.

### SUMMARY

In accordance with one aspect of the present invention, a concentrate comprising a self-emulsifying oil and an active ingredient is disclosed. The self-emulsifying oil comprises a modified vegetable oil modified to include a moiety more polar than the vegetable oil. In accordance with some aspects, the polar moiety is attached by a covalent bond to the vegetable oil through an ene reaction. In accordance with other aspects, the polar moiety is fused to the vegetable oil.

In accordance with one aspect of the present application, the self-emulsifying oils are derived from unsaturated vegetable oils. The described self-emulsifying oils can be used to formulate biologically active materials which, in certain cases, can be prepared as green formulations. The delivery systems described herein are particularly useful for the delivery of active ingredients, typically hydrophobic components, in water. Typically, the active ingredient is water-insoluble active organic compound such as a biocide, fungicide, bactericide, insecticide, herbicide, algicide, light stabilizer, disinfectant, UV absorber, synthetic hydrocarbon, radical scavenger, resin or a natural wax. The delivery system and concentrates disclosed herein are particularly useful with agriculturally active chemicals and non-acid sensitive actives.

In accordance with certain aspects, the self-emulsifying oil can act as a solvent and surfactant such that additional emulsifiers and/or solvents are not necessary. However, additional solvents and emulsifiers can also be included in the delivery matrix to provide certain performance characteristics for particular active ingredients.

### BRIEF DESCRIPTION OF THE DRAWINGS

FIG. 1 presents stability data of Tebuconazole concentrate of Example 15 via UV spectral trace from samples stored under ambient conditions and heat accelerated stored (HAT) conditions (54° C. for two weeks);

FIG. 2 presents stability data of Tebuconazole concentrate of Example 15 freshly prepared and diluted at 1/200 with WHO hard water and stored at different time intervals (0-48 hours), via UV spectral trace; and

FIG. 3 presents stability data of Tebuconazole concentrate of Example 15 heat accelerated stored (HAT) conditions (54° C. for two weeks), and diluted at 1/200 with WHO hard water and stored at different time intervals (0-48 hours), via UV spectral trace.

### DETAILED DESCRIPTION

The present application is directed to concentrates, and delivery systems prepared from the concentrates, comprising a self-emulsifying oil and an active ingredient. The self-emulsifying oil comprises a modified vegetable oil modified to include a moiety more polar than the vegetable oil. The modified oil provides both solvent and surfactant functionalities. The concentrates typically are neutralized to a pH that is particularly suited for the concentrate, delivery system and/or the active ingredient. The concentrates are suitable for forming stable aqueous use compositions upon dilution with water.

All percentages, ratios and proportions used herein are based on weight unless indicated otherwise.

The active organic compound in the concentrate and aqueous delivery system of the invention may be a substantially water-insoluble organic compound such as a biocide, fungicide, bactericide, insecticide, herbicide, algicide, disinfectant, light stabilizer, UV absorber, hydrocarbon, radical scavenger, synthetic resin and/or natural wax compound. By the term “substantially water-insoluble”, it is meant that for all practical purposes, the solubility of the compound in water is insufficient to make the compound practicably usable in the desired end use without some modification either to increase its solubility or dispersability in water, so as to increase the compound's bioavailability or avoid the use of excessively large volumes of solvent.

In accordance with certain aspects, the active ingredient may be a non-acid sensitive active. A non-acid sensitive active is an active ingredient that is stable at a pH below 7. By contrast, active ingredients that are degradable in an acid medium are considered to be acid-sensitive.

In accordance with certain aspects, the active ingredient comprises an agriculturally active chemical. As used herein, the term “agriculturally active chemical” includes compounds and mixtures thereof which can be used as agricultural fertilizers, nutrients, plant growth accelerants, herbicides, plant growth controlling chemicals, and chemicals which are effective in killing plants, insects, microorganisms, fungi, bacteria and the like which are commonly referred to as insecticides, bactericides, fungicides, nematocides, fumigants, and the like, as well as any other chemicals having properties which are suitable for agricultural uses in terms of application to plants or domestic uses for controlling insects and pests. Particularly, such chemicals would normally take the form of water-immiscible or oily liquids and/or solids which are substantially insoluble in water.

Suitable agriculturally active chemicals which can be used with the present invention include insecticides, such as, cyclocompounds, carbamates, animal and plant derivatives, synthetic pyrethroids, diphenyl compounds, non-phosphates, organic phosphates, thiophosphates, and dithiophosphates. (See Agricultural Chemicals, Book I, Insecticides, 1989 Revision by W. T. Thomson, Thomson Publications). Typical of the insecticides are:

cyclocompounds: 6,7,8,9,10,10-hexachloro-1,5,5a,6,9,9a-hexahydro-6,9-methano-2,4,3-benzodioxathiepin-3-oxide;

carbamates: 2-isopropyl phenyl-N-methyl carbamate; 2-(1,3-dioxolan-2yl) phenylmethyl carbamate; 2,3-isopropylidine dioxyphenyl methyl carbamate;

animal and plant derivatives: chlorinated hydrocarbons derived from Southern pine; naturally occurring lactone glycoside;

synthetic pyrethroids: (±) α-cyano-3-phenoxybenzyl (±) cis, trans 3-(2,2-dichlorovinyl)2,2-dimethyl cyclopropane carboxylate; (±) cyano (3-phenoxyphenyl methyl (±)-4-(difluoromethyoxy) α-(1-methylethyl) benzene acetate;

phenoxy compounds and non-phosphates: 2,2-bis(p-methoxy phenyl)-1,1,1, trichloroethane; 1,3,5,tri-n-propyl-1,3,5-triazine-2,4,6 (1H,3H,5H)trione; ethyl (2E,4E)-3,7,11-trimethyl-2,4-dodecadienoate; 1-decycloxy 4-[(7-oxa-oct-4-ynyl)]-oxybenzene;

organic phosphates: dimethyl phosphate ester of 3-hydroxy-N,N-dimethyl-ciscrotonamide; 2-chloro-1-(2,4-dichloro phenyl) vinyl diethylphosphate; 4-(methyl thio) phenyl dipropyl phosphate;

thiophosphates: 0,0-diethyl-O-4-nitrophenyl phosphorothioate; 0,0-diethyl-0-(2,isopropyl-6-methyl-5-pyrimidinyl) phosphorothioate; 2-diethylamino-6-methyl pyrimidine-4-yl dimethyl phosphorothioate;

dithiophosphates: 0,0-dimethyl phosphorodithioate ester of diethylmercapto succinate; 0-ethyl-5-phenyl ethyl phosphorodithioate.

Typical herbicides include phenoxy compounds, benzoic, acetic, and phthalic acids, aniline derivatives, nitriles, amides, acetamides, anilides, carbamates, thiocarbamates, and heterocyclic nitrogen derivatives, e.g., triazines, pyridines, pyridazones, picolinic acid, and urea derivates and phosphates. (See Agricultural Chemicals, Book II, Herbicides, 1986-87 Edition, W. T. Thomson, Thomson Publications, Fresno, Calif. 93791.) Exemplary of the above compounds are:

phenoxy compounds: 2,4-Dichlorophenoxy acetic acid; 2,4,5-trichloro phenoxyacetic acid; 4-(2,4-dichlorophenoxy)butyric acid; S-ethyl 2 methyl-4-chlorophenoxythioacetate; 2-methyl-4-chloro-phenoxy acetic acid; methyl 5-(2,4-dichloro-phenoxy)-2-nitrobenzoate;

benzoic and acetic acids of phthalic compounds: 3,6-dichloro-o-anisic acid 4-chloro-2-oxo benzothiazolin-3-yl acetic acid; N-1-Naphthyl-phthalamic acid;

nitriles and aniline derivatives: 3-5-dibromo-4-hydroxybenzonitrile; α,α,α,trifluoro-2,6-dinitro-N,N-dipropyl-p-tolinidine; N-(1-ethylpropyl)-2,6-dinitro-3,4-xylidine;

amides, acetamides, anilides: N,N-diethyl-2-(1-naphthalenyl oxy)-propionamide; 2,6-dimethyl-N-2′ methoxy-ethylchloro-acetanilide; 3′,4′-dichloro-propionanilide; α-chloracetic-N-(3,5,5-trimethylcyclohexen-1-yl)-N-isopropylamide; 4-benzyl-N-isopropyl trimethyl acetamide;

thiocarbamates: S-Ethyl dipropyl thiocarbamate;

urea derivatives: 3-(5-tert-butyl-3-isoxazoyl)-1,1-dimethyl urea; N-(2,6-trifluoro-benzoyl)-N′-[2,5-dichloro-4-(1,1,2,3,3,3-hexafluoropropyloxy) phenyl]urea;

pyrrolidone derivatives: 1-(m-trifluoro methyl phenyl)-3-chloro-4-chloromethyl-2-pyrrolidone;

amino acid derivatives: methyl N-benzoyl-N-(3-chloro-4-fluorophenyl)-DL alarinate; N-chloroacetyl-N-(2,6-diethylphenyl)-glycine ethyl ester;

carbamates: Isopropyl-m-chlorocarbanilate; 3-Ethoxy(carbonyl aminophenyl)-N-phenyl carbamate;

heterocyclics: 4-amino-3,5-dichloro-6-fluoro-2-pyridyloxy acetic acid; 4-(1,2-Dimethyl-N-propyl amino)-2-ethyl amino-6-methyl thio-5-triazine; 2-[4,5-dihydro 4-methyl-4-(1-methyl ethyl)-5-oxo-1H-imidazoyl-2yl-3-byridinecarboxylic acid; 2-[3,5-dichlorophenyl)-2-(2,2,2-trichloroethyl) oxinane; Butyl-9-hydro-fluorene-(9)-carboxylate; 2-[1-(ethoxy imino) butyl]-3-hydroxy-5-(2H-tetrahydro thiopyran-3-yl)-2-cyclohexene-ione; 2-(2 chlorophenyl) methyl-4,4-dimethyl-3-iso oxazolidinone;

phosphates: 0-ethyl-0-(3-methyl-6-nitro phenyl) N-sec-butyl phosphoro thio amidate.

Typical fungicides include (See Agricultural Chemicals, Book IV, Fungicides, 1989 Revision, W. T. Thomson, Thomson Publications, Fresno, Calif. 93791):

organic compounds: 2,5-dimethyl-N-Cyclohexyl-N-methoxy-3-furan carboxamide; 5-Ethyoxy-3-trichloromethyl-1,2,4-thiadiazole; 3-(2-methyl piperidino) propyl 3,4-dichlorobenzoate; N,N′-(1,4-piperazinediyl bis(2,2,2-trichloro) ethylidene) bis formamide; Tetramethyl thiuram disulfide; 0-Ethyl-S,S,diphenyl-dithiophosphate; 5,10-dihydro-5,10-dioxo naphtho (2,3,9)-p-dithiin-2,3-dicarbonitrile; 2-(Thiocyano methyl thio)benzothiazole; α-2-(4-chlorophenyl)ethyl]-α-(1,1-dimethyl ethyl)-1H-1,2,4-triazole-1-ethanol;

morpholines: N-tridecyl-2,6-dimethyl morpholine; 4-N-dodecyl-2,6-dimethyl morpholine;

Typical fumigants, growth regulators, repellants, and rodenticides include (See Agricultural Chemicals, Book III, Fumigants, 1988-1989 Revision, W. T. Thomson, Thomson Publications, Fresno, Calif. 93791):

growth regulants: 1,2 Dihydro-6-ethyoxy-2,2,4-trimethylquinoline; (2-chloroethyl) phosphoric acid; 4-[acetamino) methyl]-2-chloro-N (2,6-diethyl phenyl acetamide; Benzoic acid, 3,6 dichloro-2-methoxy, 2-ethoxy-1-methyl-2-oxo ethyl ester;

repellants: 0,0-dimethyl-0-[(4-methyl thio)-m-tolyl]phosphorothioate; Tetriary butyl-sulfenyl dimethyl dithio carbamate;

seed softener: 2-chloro-6-(trichlomethyl) pyridine; 5-ethoxy-3-trichloromethyl-1,2,4-thiadiazole; N-phenyl-N′-1,2,3-thiadiazol-5-yl urea;

Pesticides may be characterized by their physical properties, depending on their physical state at normal or ambient conditions, i.e., between 40° F. and 90° F. and their solubility or miscibility with water or other common organic solvents, e.g., aromatics, such as, toluene, xylene, methylated and polyalkylated naphthalenes, and aliphatic solvents.

Based on the physical properties, the pesticides may be classified into two groups. The first group includes those which are oily liquids at ambient temperatures and are immiscible with water. Specific pesticides include:

Common esters of 2,4-dichlorophenoxyacetic acid; Common esters of 2,4,5-trichlorophenoxyacetic acid; Common esters of 2-(2,4-dichlorophenoxy) propionic acid; Common esters of 2-(2,4,5-trichlorophenoxy) propionic acid; Common esters of 2,4-dichlorobutyric acid; Common esters of 2,methoxy-3,6-dichlorobenzoic acid; Common esters of 2-methyl-4-chlorophenoxyacetic acid; Piperonyl butoxide 3,4-methylenedioxy-6-propyl benzyl n-butyl diethylene glycol ether;

Bromophos ethyl: 0,0-diethyl-0-2,5-dichloro-4-bromophenyl thionophosphate, N-(2-mercaptoethyl) benzene-sulfenamide)(BETASAN®); Isobornyl Thiocyanoacetate (Thanite®); Ioxynil ester of octanoic acid; Molinate S-ethyl hexahydro-1H-azepine-1-carbothioate; PP 511 0,0-dimethyl-(2-diethylamine 4-methyl-6-pyrimidinyl) carbamate; PP 211 0,0-diethyl O-(2-diethylamine-4-methyl-6-pyrimidinyl) phosphorocarbamate; Chlordane 5-Ethoxy-3-(trichloromethyl)-1,2,4-thiadiazole (TERRAZALE®); Ethyl-s-s-dipropyl-phosphodithioate (MOCAP®); S-Ethyl dipropylthiocarbamate (EPTAM®); S-Ethyl diisobutylthiocarbamate (SUTAN®); S-n. propyl-di-n-propylthiocarbamate)(VERNAM®; S-propyl butylethylthiocarbamatae)(TILLLAM®; S-ethyl ethylcyclohexylthiocarbamate (RO-NEET®); Malathion (S-(1,2-dicarboxyethyl)-0,0-dimethyl phosphorodithioate); Diazinon (0,0-diethyl,0-(2-isopropyl-4-methyl-6-pyrimidinyl) phosphorothioate; O-Ethyl-5-phenyl-ethylphosphonodithioate (DYFONATE®); Toxaphene (Octachlorocamphene); Bromoxynil (3,5-dibromo-4-hydroxy benzonitrile ester of n.octanoic acid, 2-chloro-N-2,6-diethylphenyl-N-methoxymethylacetamide (LASSO®); Diallate S-2,3-dichloroallyl N,N-diisopropylthiolcarbamate; Triallate S-2,33-trichloroallyl N,N-diisopropylthiolcarbamate.

The second group comprises those pesticides which are solids at ambient temperatures and for all practical purposes, insoluble in water.

2,4,5-T (2,4,5-trichlorophenoxy acetic acid); Monuron (3-(p-chlorophenyl)-1,1-dimethyl urea); Diuron (3-(3,4-dichlorophenyl)-1,1-dimethyl urea) Bromacil (5 bromo-3-sec. butyl-6-methyl uracil); Isocil (5 bromo-3-isopropyl-6-methyl uracil); Linuron (3-(3,4 dichlorophenyl)-1-methoxy-1 methyl urea; Atrazine (2-chloro-4-ethylamino-6 isopropylamino-s-triazine) Simazine (2-chloro-4,6,-bis(ethylamino)-s-triazine; Dodine (n-dodecylguanidine acetate); Thiram (tetramethylthiuram disulfide); N-(mercaptomethyl)phthalimide s-(o,o dimethylphosphorodithioate) (IMIDAN®); Lindane (gamma 1,2,3,4,5,6 hexachlorocyclohexane); Folpet (N-trichloromethylphthalimide); Manazon (s-(4,6-diamino-1,3,5-triazin-2-yl methyl)dimethyl phosphorothiolthionate); Barban (4-chloro-2 butynyl m-chlorocarbanilate); Tricumba 2-methoxy-3,5,6-trichlorobenzoic acid; Trifluralin (2,6-dinitro-N,N-dipropyl-4-trifluoromethylamiline) (2,3 dihydro-5-carboxanilido-6-methyl-1,4-oxathiin) (VITAVAX®); 2,4-dichlorophenoxyacetic acid; 4-(4-chloro-2 methylphenoxy) butyric acid;

2-(2,4-dichlorophenoxy) propionic acid;

Ioxynil: 3,5 diiodo-4-hydroxybenzonitrile;

Bromoxynil: 3,5 dibromo-4-hydroxybenzonitrile;

Carbaryl: 1-naphthyl-N-methylcarbamate;

Methoxychlor: 2,2,-Bis(p-methoxyphenyl)-1,1-trichloroethane;

PP 781: 4(2-chloro phenylhydrazono)-3-methyl-5-isoxazolone*;

PP 675: 5-butyl-2-dimethylamino-4-hydroxy-6-methyl pyrimidine*;

PP 062: 5,6-dimethyl-2-dimethylamino-4 pyrimidinyl dimethylcarbamate*;

PP 149: 5-n-butyl-2 ethylamino-4-hydroxy-6 methylpyrimidine*¹; ¹ Manufactured by Imperial Chemical Industries Limited

C 6313 N′-(4-bromo-3-chlorophenyl)-N-methoxy-N-methylurea; C 6989 2,4′ dinitro-4-trifluoromethyl-diphenylether; Chloroxuron N′-4-(chlorophenoxy) phenyl-NN-dimethylurea; Dichlobenil 2,6-dichlorobenzonitrile; Diphenamid NN-dimethyl-2,2-diphenylacetamide; Fenac 2,3,6-trichlorophenylacetic acid; Fluometuron N′-(3-trifluoromethylphenyl)-NN-dimethylurea; GS 14260 4-ethylamino-2-methylthio-6-t-butyl-amino-1,3,5-triazine; PCP Pentachlorophenol; Lenacil 3-cyclohexyl-6,7-dihydro-1H-cyclo-pentapyrimidine-2,4-(3H,5H)-dione; Pyrazon 5-amino-4-chloro-2-phenyl-3-pyridazone; Metrobromuron N′-(4-bromophenyl)-N-methoxy-N-methylurea; Metoxymarc N-(4-methoxybenzoyl)-N-(3,4-dichlorophenyl)-N′,N′-dimethylurea; Neburon N-butyl-N′-(3,4-dichlorophenyl-N-methylurea NIA 11092 1,1-dimethyl-3-[3-(n-t-butyl carbamyloxy)phenyl]urea; Mecoprop 2-(4-chloro-2 methylphenoxy)propionic acid; Monolinuron N′-(4-chlorophenyl)-N-methoxy-N-methylurea; Nitrofen 2,4-dichlorphenyl 4-nitrophenylether; Propanil N-(3,4-dichlororphenyl)propionamide; Pyriclor 2,3,5-trichloro-4-pyridinol; Solan 3′-chloro-2-methyl-p-volerotoluidide; Terbacil 5-chloro-3-t-butyl-6-methyluracil; UC 22463 (SIRMATE)-3,4-dichlorobenzyl N-methylcarbamate; WL 9385 2-Azido-4-ethylamino-6-t-butylamino-s-triazine; Propachlor 2-chloro-N-isopropylacetanilide; CP 50144 2-chloro-N-2,6-diethylphenyl-N-methoxymethylacetamide; CP 31675 2-chloro-N-(2 methyl-6-t-butylphenyl)acetamide; Cypromid 3′,4′-dichlorocyclopropane carboxanilide; Fenuron NN-dimethyl-N′ phenylurea; Chlorbromuron N′-(4-bromo-3-chlorophenyl)-N-methoxy-N-methylurea; Ametryne 2-methylmercapto-4-ethylamino-6-isopropyl-amino-s-triazine; Prometryne 2-methylmercapto-4,6-bisisopropyl amino-s-triazine; DCPA dimethyl 2,3,5,6, tetrachloroterephthalate; Benefin N-butyl-N-ethyl-2,2,2-trifluoro-2,6-dinitro-p-toluidine; Nitralin 2,6-dinitro-4-methylsulfonyl-NN-dipropyl-aniline; PP 493 2,6-difluoro-3,5-dichloro-4-hydroxy pyridine; CNP 2,4,6-trichlorophenyl-4′-nitrophenyl ether; Pentachloro nitrobenzine; 1-(butile carbamoyl)-2-benzimidazol carbamic acid, methyl ester (BENLATE®).

The active suitably is present in the concentrate in an amount by weight, of about 5-50% of the concentrate, more particularly about 10-30%, and in certain cases about 15-20%.

In accordance with one aspect, a delivery matrix is described which includes a modified vegetable oil source by including a polar group (more polar than the starting vegetable oil) by introducing a polar moiety by a covalent bond. Maleate or cinnamate or other unsaturated moieties, such as partially esterified maleic acid anhydride, cinnamic acid, adipic acid, crotonic acid, gluratic acid and itaconic acid, can be used to modify the vegetable oil. Inclusion of a polar group requires an oxygen containing moiety optionally with a heteroatom. Some of the examples are: alpha-beta unsaturated carboxylic acid, anhydrides, esters, sulfonic acids, esters, phosphonic acids, phosphate esters and their salts. The reaction can be carried out in multiple steps or in one pot.

Another option to introduce a polar moiety is via a multiple step process in which the vegetable oil is derivatized followed by reaction with reagents containing polar moieties including, but not limited to, pyrrolidone, lactams, imidazole, imidazolidones, oxazolidones, organic carbonates, and acrylates. These are only some illustrative examples.

The polar moiety can be reacted with the vegetable oil by thermal condensation. Typically, the polar moiety is capable of undergoing either “ene” or “Diels-Alder” adduction to the unsaturated sites in the vegetable oil. In accordance with certain aspects of the present application, the modified vegetable oil is treated with a base to render the oil self-emulsifiable in water. Typically, the reaction is carried out at a temperature of about 150-250° C. Particularly useful vegetable oils are those containing considerable amounts of non-conjugated unsaturated fatty acid glyceride esters such linoleic and linolenic fatty acids. Due to the inherent complexity of naturally-occurring materials, many oils and fats contain a multiplicity of fatty acids and fat molecules. The only limitation in their suitability is that they comprise at least one unsaturated carbon-carbon bond for the ene grafting reaction to take place. In accordance with the “ene” reaction method for modifying the vegetable oil, all double bonds in the oil are intact. Examples of suitable oils include, without limitation, soybean oil, sunflower oil, tall oil, corn oil, linseed oil, peanut oil, safflower oil, and sesame oil. Alkylated, methylated vegetable oils and transesterified unsaturated vegetable oils can also be used.

The self-emulsifying oil suitably is present in the concentrate in an amount by weight, of about 30-90%, more particularly about 40-80% and in certain cases about 50-70%.

In accordance with one aspect of the present application, stable emulsion concentrate formulations for various active ingredients can be prepared by adjusting the pH of the parent derivatized vegetable oil using a base.

The typical base for neutralization could be selected from and not limited to: organic bases like alcohol amines (aminomethyl propanol), ethanol amine, triethanolamine, ammonia, primary, secondary and tertiary alkyl amines, arylamines, alycyclic amine, mixed alkyl/aryl amines, inorganic bases of alkali/alkaline earth metal hydroxides, like sodium/potassium, calcium hydroxides. Inorganic bases are used for formulating aqueous compositions. For non aqueous media organic bases are preferred. The base is typically used in an amount necessary to provide a suitable pH for the composition and may depend on the active ingredient, co-solvent, self-emulsifying oil, etc. The amount of the base added is generally between about 0.2-20%, more particularly 1-10% of the derivatized vegetable oil. The amount of the base depends on the nature of the base, co-solvent, the active ingredients and their relative proportions.

Although not necessary in certain compositions, it may be beneficial to include a co-solvent with some active ingredients. Examples of suitable co-solvents include but are and not limited to: N-alkyl lactams (pyrrolidones, caprolactams, valerolactams); lactones like gamma butyrolactone, valerolactone, caprolactone, esters, esters of aliphatic or aromatic or alicyclic acids and aliphatic or aromatic or alicyclic alcohols; polyols like polyalkylene glycols with EO/PO from one to 20; ether alcohols like butoxyethanol; hydroxyl acid esters like lactates, glycollates, citrates; alkyl substituted long chain acid amides; amide alcohols like Rhodia Green; dialkyl cyclic carbonates like propylene carbonate; alkyl imidazolidones; oxazolidones, hydrocarbons aliphatic, aromatic and alicyclic hydrocarbons, petroleum distillates, Solvasso brand aliphatic hydrocarbons, Exxon aro 150/200 (alkyl Naphthalenes), vegetable or plant derived oils, derivatized plant derived or synthetic oils, mono, di, and tri glycerides, alkylated oils from the triglycerides, methylated soybean or coconut oils, terpene derived oils like menthol, eucalyptol, thymol, dipentene, pine oil. The amount of the co-solvents required based on the total wt of the concentrate may be: Zero-95%, more particularly Zero-80%, and in certain cases, 5-50%. At the higher end, the inventive composition may be used as an additive for additional benefit like wetting/spreading/sustained release.

As with the co-solvents, emulsifiers are not needed in certain formulations, but may be used to expand the scope of active ingredients that can be used in conjunction with the systems disclosed herein. The choice of emulsifiers depend upon the nature and relative concentration of the active ingredients and co-solvents. Typically a combination of non ionic and anionic emulsifiers are used. Pre-formulated combinations are commercially available or can be optimized on a case by case basis. Typical component emulsifiers are: Non-ionic emulsifiers: Ethoxylated or poroxylated alkyl phenols, aromatic phenols like trystyryl phenol ethoxylates, linear or branched aliphatic or aromatic or alicyclic alcohol ethoxylates, linear or branched aliphatic/aromatic polyesters alkoxylates, Polyethoxylated castor oil, polyalkoxylated carboxylates, poly alkoxylated alkylamines, eo/po co-polymers.

Typical anionic emulsifiers are: phosphate esters derived from the non ionic components as above and their salts, alkyl sulfonamides, salts of sulfated/phosphate, or sulfonated alkyl phenyl or tristyrylphenyl alkoxylates, salts of alkyl benzene sulfonates, salts of alkyl naphthalene sulfonates, sulfonated aliphatic polyesters and their salts, phosphonated derivatives of hydroxy moieties from the nonionic emulsifiers. See, for Example, McCutcheon's Emulsifiers and Detergents (19890, published by McCutcheeon's Division of M.C. publishing Co., Glen Rock, N.J. The amount of emulsifier needed using the inventive compositions typically is zero-25%, more particularly 5-20% of the total wt of the concentrate.

The self-emulsifying oils described herein can be provided as liquid formulations such as emulsifiable concentrates (EC), microemulsifiable concentrates (MEC)/microemulsion concentrates (ME), suspension concentrates (SC), suspoemulsions (SE), emulsions in water (EW) and gels. The self-emulsifying oils can also be used to prepare solid formulations such as wettable powders (WP), water dispersible granules (WDG), water soluble granules (WSG) and tablets. Furthermore, the oils can be used in specialty formulations such as dispersible sheets.

The present application also describes processes for the preparation of formulations including the self-emulsifying oils. Some specific non-limiting examples are provided below, and variations for the process will be readily ascertainable by a person of ordinary skill in the art. The formulations produced in accordance with the present application are suitable for any number of end uses. Specific end uses include, without limitation, crop protection and as a sticker for vegetable oil adjuvants.

The final use concentration values depend on the active ingredient and other components of the system. However, it is important that upon dilution, the diluted form remain stable for a time sufficient to allow it to be utilized. This, of course, will vary with the particular application. With the present invention, prolonged stability of the emulsified concentrate, as is, as well as in the diluted form is obtained. In particular, the emulsified concentrate in accordance with the present invention can be diluted to final use concentrations in the range from about 10 ppm to 2 percent, depending on the specific active, without any adverse effects, and specifically, without precipitation of the active from the solution.

### EXAMPLES

Examples 1-4 describe use of the “ene” reaction to modify vegetable oil to include a polar group. Some of the ethyl maleated soy oil and similarly prepared ethyl, maleated linseed oil compositions via ene reaction were used without any co-solvents and were found to have high viscosity on neutralization. However, on mixing with vegetable oils the viscosity was reduced and the mixtures with optionally optimized emulsifiers are usable to produce emulsifiable concentrates of active ingredients.

### Example 1

### Maleation Reaction 1: Grafting Maleic Anhydride onto Soybean Oil Without Initiator

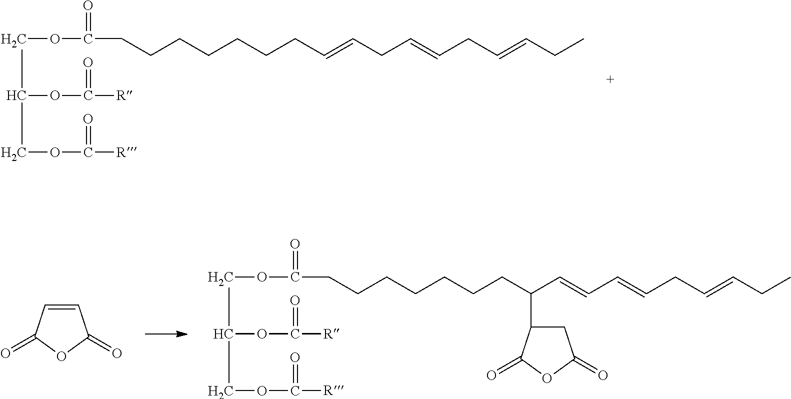

R″ and R″′ are alkyl or alkenyl groups that naturally occur in soybean oil.

### Example 1A

### Maleated Soybean Oil Via “Ene” Reaction (12112-003-7 Precursor)

Into a 1-L, 4-necked flask equipped with a thermocouple, a condenser, a nitrogen purge adaptor, and a mechanical stirrer, 500 g soybean oil was charged. The temperature was slowly raised over 60 minutes from room temperature (about 22° C.) to 210° C. Charged 150 g of maleic anhydride over 1 hour (25 g for every 10 minutes) and then held isothermally at 210° C. for 7 hours. Completion of the reaction was indicated when a drop of the reacting solution did not turn triphenylphosphine test paper orange-red.

### Example 1B

### Ethyl Maleated Soybean Oil (12112-003-7)

Into a 1-L, 4-necked kettle equipped with a thermocouple, a condenser, a nitrogen purge adaptor, and a mechanical stirrer, 350 g of composition from Example 1A was held at a temperature around 22° C., and 350 g ethanol was added. The contents were stirred and heated to reflux for 2 days. The excess ethanol was removed by evaporation in a rotary vacuum equipment under reduced pressure. Other lower (C1-C4) alcohols such as methanol and butanol can be used in place of ethanol.

### Example 2 A

### Maleated Soybean Oil Via “Ene” Reaction (12049-133-14 Precursor)

In a 3-L, 4-necked flask equipped with a thermocouple, a condenser, a nitrogen purge adaptor, and a mechanical stirrer, 2100 g soybean oil were charged. The mixture was heated to 130° C. under nitrogen purge, and held isothermally for 30 minutes. Then, 21 g of di-tert-butyl peroxide (DTPO) were charged, and then 35 g of maleic anhydride were charged every 10 minutes over the course of 1 hour (total amount of maleic anhydride charged: 210 g). Thirty minutes later, another 21 g of DTPO were charged to the vessel. The reactor was held isothermally at 130° C. for about 7.5 hours. Completion of the reaction was indicated when a drop of the reacting solution failed to turn triphenylphosphine test paper orange-red.

### Example 2 B

### Ethyl Maleated Soybean Oil (12049-133-14)

Into a 1-L, 4-necked kettle equipped with a thermocouple, a condenser, a nitrogen purge adaptor, and a mechanical stirrer, 350 g of composition from Example 2A was held at a temperature around 22° C., and 350 g ethanol was added. The contents were stirred and heated to reflux for two days. The excess ethanol was removed by evaporation in a rotary vacuum equipment under reduced pressure.

### Example 3 A

### Maleated Linseed Oil Via “Ene” Reaction (12112-035 Precursor)

In a 1-L, 4-necked flask equipped with a thermocouple, a condenser, a nitrogen purge adaptor, and a mechanical stirrer, 400 g linseed oil were charged. The mixture was heated to 130° C. under nitrogen purge, and held isothermally for 30 minutes. Then, 4.0 g of di-tert-butyl peroxide (DTPO) were charged, and then 6.67 g of maleic anhydride were charged every 10 minutes over the course of 1 hour (total amount of maleic anhydride charged: 40 g). Thirty minutes later, another 4.0 g of DTPO were charged to the vessel. The reactor was held isothermally at 130° C. for about 7.5 hours. Completion of the reaction was indicated when a drop of the reacting solution failed to turn triphenylphosphine test paper orange-red.

### Example 3 B

### Ethyl Maleated Linseed Oil (2112-035)

Into a 1-L, 4-necked kettle equipped with a thermocouple, a condenser, a nitrogen purge adaptor, and a mechanical stirrer, 400 g of composition from Example 3A was held at a temperature around 22° C., and 160 g ethanol was added. The contents were stirred and heated to reflux for two days. The excess ethanol was removed by evaporation in a rotary vacuum equipment under reduced pressure.

### Example 4 A

### Maleated Linseed Oil Via “Ene” Reaction (12112-038 Precursor)

In a 1-L, 4-necked flask equipped with a thermocouple, a condenser, a nitrogen purge adaptor, and a mechanical stirrer, 350 g linseed oil were charged. The mixture was heated to 130° C. under nitrogen purge, and held isothermally for 30 minutes. Then, 3.5 g of di-tert-butyl peroxide (DTPO) were charged, and then 5.8 g of maleic anhydride were charged every 10 minutes over the course of 1 hour (total amount of maleic anhydride charged: 35 g). Thirty minutes later, another 3.5 g of DTPO were charged to the vessel. The reactor was held isothermally at 130° C. for about 7.5 hours. Completion of the reaction was indicated when a drop of the reacting solution failed to turn triphenylphosphine test paper orange-red.

### Example 4 B

### Ethyl Maleated Linseed Oil (12112-038)

Into a 1-L, 4-necked kettle equipped with a thermocouple, a condenser, a nitrogen purge adaptor, and a mechanical stirrer, 350 g of composition from Example 4A was held at a temperature around 22° C., and 240 g ethanol was added. The contents were stirred and heated to reflux for two days. The excess ethanol was removed by evaporation in a rotary vacuum equipment under reduced pressure.

Compositions of examples 1 through 4 were evaluated as delivery matrices for Tebuconazole and Propiconazole fungicides, after appropriate neutralization with Aminomethyl ethanol. Note different pH for different combination of matrix and AI as indicated in the following Examples.

### Example 5

An emulsifiable concentrate was prepared as follows: 20 g of technical Tebuconazole (98.3% purity) was dissolved in a mixture containing 50.5 g of the composition of Example 1B and 25 g of co-solvent (dimetly amide of fatty acids), commercially available Agnique KE 3658. A minimum of 4.5 g commercially available aminomethyl propanol (AMP) base was added to produce a pH of 8.4 at 1/10 dilution. The concentrate was stable on storage at ambient condition without any separation.

On dilution with WHO 342 ppm hard water at 1/100 produced stable emulsion with no cream or oil separation when stored for 90 h.

### Example 6

Example 5 was repeated using 51 g of the composition of Example 1B and 4 g of AMP to produce pH 8.2 at 1/100 dilution. The concentrate at dilution with WHO 342 hard water at 1/100 produced 0.5 mm of sinking oil, on standing for 24 h, from a 30 mm column of liquid.

### Example 7

Example 5 was repeated using inventive composition of Example 2B in the place of Example 1. Similar results were obtained. pH at 1/10 dilution of the concentrate was 8.5. The concentrate produced stable emulsion on dilution with hard water with no oil separation for 90 h.

### Example 8

Example 6 was repeated with the inventive composition Example 2B in the place of Example 1. Results were similar with separation of oil with AMP less than 4.5 g in the concentrate.

### Example 9

An emulsifiable concentrate was prepared as follows: 20 g of technical Tebuconazole (98.3% purity) was dissolved in a mixture containing 52.5 g of the composition of Example 3B and 25 g of co-solvent (dimethyl amide of fatty acids), commercially available Agnique KE 3658. A minimum of 2.5 g commercially available aminomethyl propanol (AMP) base was added to produce a pH of 8.9 at 1/10 dilution. The concentrate was stable on storage at ambient condition without any separation.

On dilution with WHO 342 ppm hard water at 1/100 produced stable emulsion with no cream or oil separation when stored for 90 h.

### Example 10

Example 9 was repeated using 53 g of the composition of Example 3B and 2 g of AMP to produce pH 8.7 at 1/100 dilution. The concentrate at dilution with WHO 342 hard water at 1/100 produced 0.5 mm of floating cream on standing for 24 h, and 1 mm floating cream oil on standing for 48 h, from a 30 mm column of liquid.

### Example 11

Example 9 was repeated using inventive composition of Example 4B in the place of Example 3B. Similar results were obtained. pH at 1/10 dilution of the concentrate was 9.1. The concentrate produced stable emulsion on dilution with hard water with no oil separation for 90 h.

### Example 12

Example 11 was repeated using 53 g of the composition of Example 4B and 2 g of AMP to produce pH 8.8 at 1/100 dilution. The concentrate at dilution with WHO 342 hard water at 1/100 produced 0.5 mm of floating cream on standing for 24 h, and 1 mm floating cream oil on standing for 48 h, from a 30 mm column of liquid.

### Example 13

An emulsifiable concentrate was prepared as follows: 20 g of Propiconazole was dissolved in a mixture containing 60.2 g of the composition of Example 2B and 15 g of co-solvent (dimethyl amide of fatty acids), commercially available Agnique KE 3658. 4.8 g commercially available aminomethyl propanol (AMP) base was added to produce a pH of 8.5 at 1/10 dilution. The concentrate was stable on storage at ambient condition without any separation.

On dilution with WHO 342 ppm hard water at 1/100 produced stable emulsion with no cream or oil separation when stored for 90 h.

### Example 14

Example 13 was repeated with 61.3 g inventive composition of Example 3B in the place of 60.2 g Example 2B, and 3.7 g AMP to produce a pH of 8.4 at 1/10 dilution.

On dilution with WHO 342 ppm hard water at 1/100 produced stable emulsion with no cream or oil separation when stored for 90 h

### Example 15

Tebuconazole was successfully formulated as a stable 20% EC using BOMOL 4 (Ashland Chemicals), as the primary solvent/emulsifier in combination, AMP-100 [AMINO methyl propanol] as pH modifier, and commercially available dialkyl long chain acid amides as co-solvents.

Initial pH of the concentrate was adjusted to 9.2 (at 1/10 dilution in water). UV test results showed that Tebuconazole was stable in the concentrate with no obvious decomposition before and/or after HAT (heat accelerated storage, 30 days at 54° C.).

The 20% EC formed stable emulsions on dilution at 1/200 with hard water. Before HAT, emulsion stability on dilution was excellent observed for 7 days, without any cream/oil/solid separation. After HAT, emulsion on dilution was stable, observed for 24 hrs, via microscopic observation and through UV spectral data. Emulsion particle/droplet size of Tebuconazole was ˜3 um.

The matrix is capable of sustained release potentials.

Formulations

Compositions tested are shown in Table 1 and 2. Following ingredients, obtained from commercial sources were used: SEO (pre-neutralized), A. I. (active ingredient), and co-solvent.

Preparation Procedure

Weighed quantities of all the ingredients were charged in a glass bottle in the following order. SEQ, AMP, the contents were stirred at RT (room temperature) via a magnetic stirrer (there was a slight exotherm). The active ingredient was dissolved, followed by addition of the co-solvent. The content was stirred for about 1-2 hours until all components were dissolved forming a homogeneous optically clear EC composition.

Performance Test/Emulsion Stability

Emulsion stability was measured according to GB/T 1603-2001: 100 ml of standard hard water was measured into a 100 ml measuring cylinder, then 0.5 ml of EC composition was gently poured on to the surface of the water in the measuring cylinder, by using a syringe. The cylinder was stoppered and was inverted 30 times until the entire composition was emulsified with bloom. The cylinder was left to stand undisturbed at 30±2° C. for 1 hr. At the end of the time, stability of the emulsion was measured by observing for the presence of any floating oil, sinking oil or deposit.

Storage stability at 0±2° C.

The storage stability at low temperature was measured according to MT 39.3 or GB/T 19137-2003. 100 ml of sample was added into a centrifugal tube and kept at 0±2° C. for 7 days, and the contents were checked for any separation of solid/oil matter, and the results were recorded.

Storage stability at 54±2° C.

The storage stability at high temperature was measured according to MT 46.3 or GB/T 19136-2003. 30 ml of sample was added into an ampere bottle and sealed, weighed and kept at 54±2° C. for 30 days. The contents were checked for any separation of solid/oil matter and the results were recorded. The sample was weighed after the heat-storage was completed. There was no change in the weight. The active ingredient in the sample was then analyzed by a suitable analytical method

pH Measurement

pH was measured for aqueous solutions produced by diluting non aqueous solutions by 1/10 dilution. Mettler Toledo PB-10 pH meter, glass electrode, Model Delta 320, were used. The glass electrode was calibrated using standard buffers at pH 4.0 and pH 8.0.

Particle Size

Particle size distribution was measured through an optical microscope, Leica DM 2500; with a magnification at 1/500 and the average droplet size was via manual counting on the calibrated scale. Additionally select samples were analyzed using Malvern/Microtrac particle analyzer to obtain the particle distribution spectra

Turbidity

All turbidity measurements were made using standard turbidimeter Model 2100 P and using standardized solutions with calibrated turbidity.

Analytical Recovery of A.I. From Concentrate and Dilution

Standard dilutions of the pre-screened concentrate and dilution samples were prepared in a suitable solvent and were used for analytical determination of the A.I. in the diluted samples. The dilutions were made to obtain a suitable response to scale for the quantitatively diluted samples. From the pre-calibrated instrumental response (UV or HPLC or GC) the actual recovery of samples were calculated. In the case of Tebuconazole, concentrate and aqueous diluted emulsion samples were used to obtain the entire UV spectra to establish finger print match for the zero time and accelerated stored samples. The matrix used were determined to be transparent in the UV range studied.

Table 1 summarizes the composition and results of stability of both the concentrate and diluted aqueous emulsion samples at 1/200 dilutions using 342 ppm WHO hard water. The initial pH of EC was adjusted/optimized to 9.2 by using 4% commercial aminomethyl propanol as the base.

The extent of neutralization to pH ˜9.0 at 1/10 dilution was found necessary to obtain good emulsion stability on dilution. On heat storage at 52° C. for one month, there was a slight drop in the pH measured at 1/10 dilution. The pH dropped to 8.8 and did not affect the emulsion stability on dilution from the heat stored EC as above.

Table 2 summarizes results from scaled up samples from 10 g to 150 g.

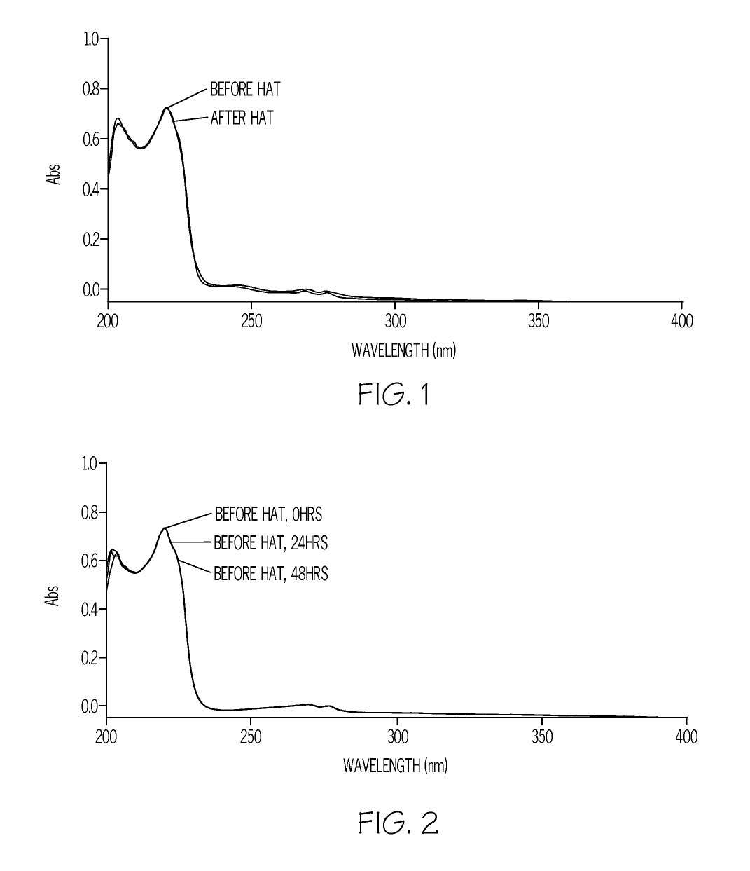

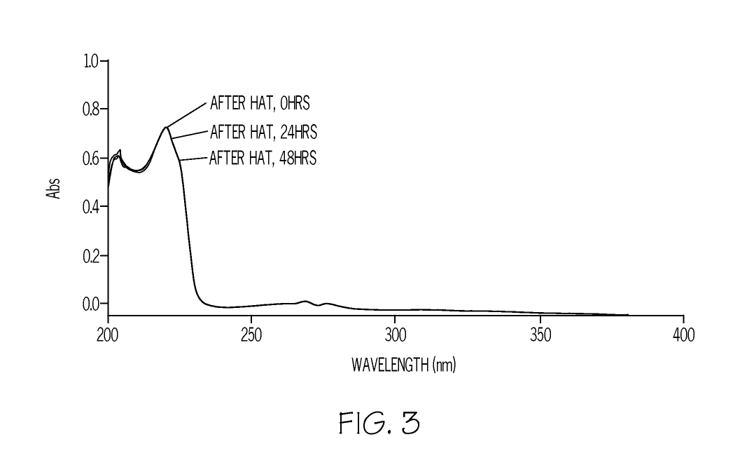

Suitable emulsions were obtained on 1/200 dilution of the 20% scaled up EC, before and after HAT (heat accelerated storage). The actual concentrate was optically clear. FIG. 1 shows the entire UV spectra of the 20% EC after suitable dilution in Ethanol before and after HAT. FIG. 2 shows the UV spectra obtained from the aqueous, 1/200 diluted EC samples before HAT at different storage-time intervals and FIG. 3 shows the corresponding spectra obtained using the EC after HAT. As shown in the attached drawings, there is no change in the spectral trace showing that the Tebuconazole molecule is stable in the formulations under heat stored conditions both in concentrate and on dilution.

It is clear from the results that both EC concentrate and aqueous diluted samples are stable with no separation.

Bomol 4 is derived from natural resources and acts as a solvent, emulsifier for a number of active ingredients. Use of co-solvents and additional emulsifiers is optional as in the case of Tebuconazole, additional co-solvent improved loading and stability considerably. Bomol 4 is also capable of forming films on surfaces on partial drying, capable of sustained release via internal cross linking. It can also be used as a sticker in oil based adjuvants. The EC made from Bomol 4 may not require additional oil based adjuvants.

TABLE 1
20% Tebuconazole EC Formulation Based on Bomol 4 with co-solvent
and Performance Test Results

| | | | Ag002-017 | |
|---|---|---|---|---|
| Lot No | | | | D |
| Formulation & Remarks | | | C | (repeat) |
| Composition | Supplier | Function | % | % |
| Tebuconazole, | Nutriechem Co., Ltd | A.I. | 20 | 20 |
| 98.3% | | | | |
| Bomol 4 | Ashland | SEO | 56 | 56 |
| | | [Solvent/Emulsifier in | | |
| | | one product] | | |
| AMP-100 | ISP Biochema/ | PH modifier | 4 | 4 |
| | Lehmann & Voss | | | |
| Fatty acid | Cognis | Cosolvent | 20 | 20 |
| dimethylamides | | | | |

| | | |
|---|---|---|
| Total | 100 | 100 |
| Test Items | | |
| PH (10% Sol.) before HAT* | 9.2 | 9.2 |
| PH (10% Sol.) after HAT* | 8.8 | 8.8 |

| Emulsion Stability (×200) | | |
|---|---|---|
| before HAT*, 342 ppm, @ RT, | | |
| Solid/Cream/Oil (mm³) | Top & bottom | Top & bottom |
| 0 hr | 0 | 0 |
| 24 hr | 0 | 0 |
| 7 d | 0 | 0 |
| Emulsion Stability (×200) | | |
| after HAT*, 342 ppm, @ RT, | | |
| Solid/Cream/Oil (mm³) | Top & bottom | Top & bottom |
| 0 hr | 0 | 0 |
| 2 hr | 0 | 0 |
| 4 hr | 0 | 0 |
| 24 hr | 0.1 | 0.1 |
| Storage @ 0 ± 2° C. | | |
| 1 d | clear | clear |
| 2 d | clear | clear |
| 7 d | clear | clear |
| Storage @ 54 ± 2° C. | | |
| 1 d | clear | clear |
| 7 d | clear | clear |
| 30 d | clear | clear |

HAT*stored @ 54 ± 2 for 30 days

TABLE 2
Scale-up of 20% Tebuconazole EC Formulation and Performance Test Results

| Formulation | | | Ag002-024 | |
|---|---|---|---|---|
| Composition | Supplier | Function | % | W, g |
| Tebuconazole, 98.3% | Local (Nutriechem Co., Ltd) | AI | 20 | 20 |
| Bomol 4 | Ashland | SEO | 56 | 56 |
| AMP-100 | ISP Biochema/ | pH | 4 | 4 |
| | Lehmann & Voss | modifier | | |
| Fatty acid | Cognis | Cosolvent | 20 | 20 |

dimethylamides

| Test Items | | |
|---|---|---|
| Concentration of Tebuconazole | 20% | |
| Appearance | very clear | |
| PH (10% Sol.) before HAT* | 9.2 | |
| PH (10% Sol.) after HAT* | 8.8 | |
| | Top & bottom | |
| | before | after |
| Emulsion Stability (×200), 342 ppm, @ RT, Solid/Cream/Oil (mm) | HAT* | HAT* |
| 0 hr | 0 | 0 |
| 1 hr | 0 | 0 |
| 4 hr | 0 | 0 |
| 24 hr | 0 | 0.1 |

| | |
|---|---|
| Storage @ 0 ± 2° C. | |
| 1 d | very clear |
| 7 d | very clear |
| Storage @ 54 ± 2° C. | |
| 1 d | very clear |
| 7 d | very clear |
| 30 d | very clear |

Tebuconazole was formulated as 20% EC, using Agsol Ex SEO (Bomol 4) as the primary solvent/emulsifier in combination, co-solvent-Di methyl amides of long chain acids, a neutralizer (HALCOMID M 8-10—from Stepan), Aminomethyl propanol. The initial pH was adjusted at 9.2 (1/10 dilution in water). After accelerated heat storage at 54° C. for 30 days the pH dropped slightly to 8.8 at 1/10 dilution in water. Both 20% concentrate and aqueous hard-water diluted samples (1/200) were found to be stable, with emulsion droplet size ˜3 microns.

The use of Bomol 4 SEO as a solvent-surfactant in combination was established using several other active ingredients. Key factor in formulating was found to neutralize the free acid component in SEO to an optimum pH. Several bases could be used for the pH optimization. The SEO could have additional benefits like sustained release of the active ingredients, and adjuvant effects and flow modifications.

### Example 16-18

Similarly other active ingredients were formulated using co-solvents and additional emulsifiers as needed.

### Example 16

Chlorpyrifos, 50% EC couldn't be self-emulsified with Bomol 4, until using AMP-95 to adjust pH of formulation to 8.4 at 1/10 dilution, and emulsion dilution (×200) could be stable within 24 hours, but after stored @ RT for 4 days, some cream appears at the bottom of emulsion dilution. Storage of EC samples @ 540 C for 14 days is stable, while it will be gel when stored @0° C. Emulsion at 1/200 dilution of the 50% concentrate showed average particle size is about 4 μm.

### Example 17

Ametraz, 20% EC couldn't be self-emulsified with Bomol 4, until using AMP-95 at 5% to adjust pH of formulation at 1/10 dilution in water to 9.3, and emulsion dilution (×200) was stable for several days. Storage of EC samples @ 0° C. & 540 C for 7 days and 14 days is stable. Emulsion at 1/200 dilution of the 20% concentrate showed average particle size is about 4 μm.

### Example 18

When example 17 was repeated using 4% or less AMP—95, the emulsion quality

Was poor with cream separation on dilution of the concentrate at 1/200

### Example 19

Fipronil, 20% EC was prepared using AGNIQUE KE-3658 (Halcomid) as co-solvent along with Bomol 4, in the ratio 41:35, and had to use AMP-95 at 4% to adjust pH of formulation to 9.6 at 1/10 dilution. Emulsion dilution (×200) could be stable within 24 hrs, while 2 days later there is some cream at the bottom. Storage @ 00 C & 540 C for 7 days and 14 days is stable. Emulsion at 1/200 dilution of the 20% concentrate showed average particle size is about 5 μm.

### Example 20

When example 19 was repeated using 3% or less AMP—95, the emulsion quality

Was poor with cream separation on dilution of the concentrate at 1/200

### Example 21

Bomol 4 and other SEQ's described herein can also be used as a drift control additive as tank mix application.

Typical aerial spray solutions were made using a commercial product: Power MAX as the base at the rate of 22 oz/ac as control along with following drift control agents at the specified dose: a) standard drift control Agent (polyacrylamide 37% in water) at 4 oz/100 gal. and b) Ethyl maleated linseed oil neutralized with AMP 95 to produce 18.5% aqueous solution at pH ˜7.0 sprayed at 4 oz/100 gal and c) Ethyl maleated linseed oil neutralized with AMP 95 to produce 18.5% aqueous solution at pH ˜7.0 sprayed at 12 oz/100 gal. Following parameters were used:

Nozzle: CP 11TT-4008; Angle: 45.00 deg; pressure: 40 psi: Speed: 130 MPH. Droplet (volume diameter) spectra measured via Laser scattering technique was found to be as follows: Sample b) showed larger droplet size on the smaller fractions at doze ½ of the standard drift control agent.

| Product | | | |
|---|---|---|---|
| composition | Dv 0.1 (μm) | Dv 0.5 (μm) | Dv 0.9 (μm) |
| a | 86.3 | 210.4 | 372.7 |
| b | 95.7 | 214.6 | 358.0 |
| c | 96.9 | 215.2 | 359.9 |

### Example 22

Experiment 21 was repeated at a higher speed at 160.00 MPH instead of 130 MPH and relative results are shown below:

| Product | | | |
|---|---|---|---|
| composition | Dv 0.1 (μm) | Dv 0.5 (μm) | Dv 0.9 (μm) |
| a | 69.8 | 167.6 | 291.5 |
| b | 76.0 | 167.3 | 278.1 |
| c | 76.1 | 167.9 | 283.6 |

The blank sample (power max alone at the identical dose showed Dv 0.1 (μm)=65.1; Dv 0.5 (μm)=158.2; and Dv 0.9 (μm)=277.4

### Example 23-35

Combination of Bomol 4 (neutralized and unneutralized) with commercially available methylated vegetable oils (used in crop protection): NMP, Halcomid, PEG, Exxon aro 150, Banana oil, Pine oil, methyl oleate, methyl soyate, Methylated coconut oil with or without emulsifiers are shown to emulsify in water.

A combination of Bomol 4 and methylated vegetable oil was prepared and optimized emulsifiers were designed and diluted in water to produce stable emulsions. Such matrices can be used to formulate active ingredients in an oil based concentrate. The following examples provide compositions exhibiting oil compatibility, solvent compatibility and emulsifier compatibility.

### Example 23

Commercially available ethyl maleated linseed oil was neutralized by using aminomethyl propanol (2-3%) to produce a pH of 7-8 on dilution in water. The neutralized version was mixed with N methylpyrrolidone 10-40%. The homogeneous compositions could be solubilized in water on dilution.

### Example 24

Example 23 was repeated with commercially available N,N dimethyl octanamide/decanamide mixture, and produced essentially similar results.

### Example 25

Example 23 was repeated using 10% polyethylene glycol (PEG 400) and produced essentially similar results.

### Example 26

### Example

Example 23 was repeated using 20% Exxon Aro 150+5% Ca dodec benz sulfonate (70%) and produced essentially similar results.

### Example 27

Commercially available Ethyl maleated Linseed oil, Bomol 4 (Ashland Chemical) was completely miscible with commercial Banana oil at 1:0.2 wt. ratio. This mixture was emulsified using 8% emulsifier mix containing Ca dodecyl benzene sulfonate (75%), and Soprophor BSU (tristyryl ethoxylate) with 16 EO in the wt. ratio 1:1. The mixed homogeneous composition produced stable emulsions with <5 micron droplet size stable for >24 hours, on dilution with WHO hard water with 342 ppm hardness at 1/50, 1/100, and 1/500 dilution. The pH of the concentrate at 1/10 dilution was 4.8

### Example 28

Example 27 was repeated using partially neutralized Bomol using aminomethyl propanol to produce a pH of 7.6 on 1/10 dilution in water, and essentially produced similar results. There concentrate was not optically clear, it was slightly cloudy.

### Example 29

Commercially available Ethyl maleated Linseed oil, Bomol 4 (Ashland Chemical) was completely miscible with commercial Pine Oil at 1:1 wt. ratio. This mixture was emulsified using 8% emulsifier mix containing Ca dodecyl benzene sulfonate (70%), and Soprophor BSU (tristyryl ethoxylate) with 16 EO in the wt. ratio 1:1. The mixed homogeneous composition produced stable emulsions with <5 micron droplet size stable for >24 hours, on dilution with WHO hard water with 342 ppm hardness at 1/50 and 1/100 dilution. The pH of the concentrate at 1/10 dilution was 5.8

### Example 30

Example 29 was repeated using partially neutralized Bomol using aminomethyl propanol to produce a pH of 7.9 on 1/10 dilution in water and essentially produced similar results.

### Example 31

Commercially available Ethyl maleated Linseed oil, Bomol 4 (Ashland Chemical) was completely miscible with commercial methyl oleate at 1:1 wt. ratio. This mixture was emulsified using 10% emulsifier mix containing Ca dodecyl benzene sulfonate (70%), and Soprophor BSU (tristyryl ethoxylate) with 16 EO in the wt. ratio 4:6. The mixed homogeneous composition produced stable emulsions with <5 micron droplet size stable for >24 hours, on dilution with WHO hard water with 342 ppm hardness at 1/50, 1/100, and 1/500 dilution. The pH of the concentrate at 1/10 dilution was 5.5. After neutralization of the Bomol with aminimethyl ethanol (to pH 7.8 at 1/10 dilution), produced essentially similar results.

### Example 32

Commercially available Ethyl maleated Linseed oil, Bomol 4 (Ashland Chemical) was completely miscible with commercial methylated Soybean at 1:1 wt. ratio. This mixture was emulsified using 8% emulsifier mix containing Ca dodecyl benzene sulfonate (70%), Caster oil ethoxylate with 40 EO and Soprophor BSU (tristyryl ethoxylate) with 16 EO in the wt. ratio 3:1:1. The mixed homogeneous composition produced stable emulsions with <5 micron droplet size stable for >24 hours, on dilution with WHO hard water with 342 ppm hardness at 1/50 and 1/100 dilution. The pH of the concentrate at 1/10 dilution was 6.

### Example 34

Example 33 was repeated using partially neutralized Bomol using aminomethyl propanol to produce a pH of 7.9 on 1/10 dilution in water and essentially produced similar results.

### Example 35

Commercially available Ethyl maleated Linseed oil, Bomol 4 (Ashland Chemical) was completely miscible with commercial methylated coconut oil (Cognis) at 1:1 wt. ratio. This mixture was emulsified using 10% emulsifier mix containing Ca dodecyl benzene sulfonate (50%), Sorbitan stearate ethoxylate (Tween 60) and Soprophor BSU (tristyryl ethoxylate) with 16 EO in the wt. ratio 3:1:1. The mixed homogeneous composition produced stable emulsions with <5 micron droplet size stable for >24 hours, on dilution with WHO hard water with 342 ppm hardness at 1/200 dilution. The pH of the concentrate at 1/10 dilution was 5.6

### Example 35

Example 34 was repeated using partially neutralized Bomol using aminomethyl propanol to produce a pH of 7.4 on 1/10 dilution in water and essentially produced similar results with emulsion stability for 8 hours.

### Example 36

The alkyl maleated vegetable oils can be used as tank mix additives or as additives in a commercial liquid formulations or in solid formulations to provide one or more of the following beneficial effects:

Improved wetting, drift control, sticking capability, and sustained release.

Additionally polymers that could exist at the oil-water interface like Ganex 216 can also be included in such compositions to provide film-forming at the interface to enhance sticking properties on the target surface (foliar surface, ground application on the soil, on animal torso for insecticides. Formation of film on the leaf can enhance fungicidal activity for applied foliar fungicides.

While the invention has been described with particular reference to certain embodiments thereof, it will be understood that changes and modifications may be made which are within the skill of the art.

What is claimed is:

1. A concentrate comprising:
a self-emulsifying oil comprising a modified vegetable oil wherein said modified vegetable oil is modified by reacting vegetable oil with a moiety more polar than the vegetable oil wherein the polar moiety is attached by a covalent bond to the vegetable oil through an ene reaction; and
an active ingredient.

2. A concentrate according to claim 1 wherein the polar moiety comprises maleic anhydride.

3. A concentrate according to claim 1 wherein the vegetable oil comprises soybean oil.

4. A concentrate according to claim 1 wherein the modified vegetable oil is neutralized with a base.

5. A concentrate according to claim 4 wherein the base is aminomethyl propanol.

6. A concentrate according to claim 1 wherein the active ingredient comprises a water-insoluble active organic compound.

7. A concentrate according to claim 6 wherein the water-insoluble active organic compound is an agriculturally active chemical.

8. A concentrate according to claim 7 wherein the agriculturally active chemical is a herbicide selected from the group consisting of phenoxy compounds, benzoic acid, acetic acid, phthalic acid, aniline derivatives, nitriles, amides, acetamides, anilides, carbamates, thiocarbamates, heterocyclic nitrogen derivatives, urea derivatives, and phosphates.

9. A concentrate according to claim 1 which includes a cosolvent.

10. A concentrate according to claim 9 wherein said solvent is fatty acid dimethylamides.

11. A concentrate according to claim 1 wherein said active is selected from the group consisting of ametryn, propiconazole, propanil, tebuconazole and mixtures thereof.

12. A concentrate according to claim 1 wherein said active is a non-acid-sensitive active ingredient.

13. A concentrate according to claim 12 wherein said modified vegetable oil is neutralized with a base.

14. An aqueous delivery system comprising the concentrate of claim 1 and water of dilution.

15. A concentrate comprising:
a self-emulsifying oil comprising a modified vegetable oil wherein said modified vegetable oil is modified by reacting vegetable oil with a moiety more polar than the vegetable oil wherein the polar moiety is attached by a covalent bond to the vegetable oil; and
a water-insoluble active organic compound wherein said active is a non-acid-sensitive active ingredient.

16. A concentrate according to claim 15 wherein the polar moiety comprises maleic anhydride.

17. A concentrate according to claim 15 wherein the vegetable oil comprises soybean oil.

18. A concentrate according to claim 15 wherein the modified vegetable oil is neutralized with a base.

19. A concentrate according to claim 18 wherein the base is aminomethyl propanol.

20. A concentrate according to claim 15 wherein the water-insoluble active organic compound is an agriculturally active chemical.

21. A concentrate according to claim 20 wherein the agriculturally active chemical is a herbicide selected from the group consisting of phenoxy compounds, benzoic acid, acetic acid, phthalic acid, aniline derivatives, nitriles, amides, acetamides, anilides, carbamates, thiocarbamates, heterocyclic nitrogen derivatives, urea derivatives, and phosphates.

22. A concentrate according to claim 15 which includes a cosolvent.

23. A concentrate according to claim 22 wherein said solvent is fatty acid dimethylamides.

24. A concentrate according to claim 15 wherein said active is selected from the group consisting of ametryn, propiconazole, propanil, tebuconazole and mixtures thereof.
